(19) United States
(12) Patent Application Publication
(10) Pub. No.: US 2014/0308001 A1
(43) Pub. Date: Oct. 16, 2014

(54) Optical Fibre and Method of Fabricating a Coupling Device Therefor

(71) Applicants: Yeqi Lao, Guangzhou (CN); Xiefu Lei, Shenzhen (CN); Adrian Perrin Janssen, Exwick (GB); Nadhum Kadhum Zayer, Newton Abbot (GB)

(72) Inventors: Yeqi Lao, Guangzhou (CN); Xiefu Lei, Shenzhen (CN); Adrian Perrin Janssen, Exwick (GB); Nadhum Kadhum Zayer, Newton Abbot (GB)

(73) Assignee: OCLARO TECHNOLOGY LIMITED, Caswell Towcester Northamptonshire (GB)

(21) Appl. No.: 14/236,434

(22) PCT Filed: Jul. 24, 2012
(86) PCT No.: PCT/GB2012/051767

§ 371 Date: Apr. 24, 2014

(30) Foreign Application Priority Data
Aug. 3, 2011 (CN) 201110221481.5

(51) Int. Cl. G02B 6/42; B29D 11/00

(52) U.S. Cl. CPC G02B 6/4212; B29D 11/0075; B29D 11/00692; B29D 11/00663
USPC 385/33; 385/15; 264/1.25

(57) ABSTRACT

The present invention discloses an optical fibre (20) for coupling to an optical source (18) which includes a core (22) and a tip portion (36). The core (22) is for receiving light directed from the optical source along an optical axis; wherein the core is expanded near one end of the optical fibre, and the expanded core (24) having a diameter larger than other portions of the core that are not expanded. The tip portion (36) is on the end of the optical fibre, wherein the tip portion further includes an endmost face (26), the endmost face being non-perpendicular to the optical axis. A coupling system including such an optical fibre and a method of fabricating a coupling device for the optical fibre are also disclosed. The optical fibre as provided by the present invention not only enables high coupling efficiency with different laser mode sizes, but also reduces the back reflected laser from the optical fibre which may otherwise damage the laser semiconductor chip.

### FIELD OF INVENTION

This invention relates to an optical component, and in particular an optical component capable of coupling light to/from another optical device.

### BACKGROUND OF INVENTION

In optical communication systems, information is transmitted by carrier waves of optical frequencies that are generated by sources such as lasers or light-emitting diodes. Optical communication systems are desirable over conventional communication systems because of a greatly increased number of communication channels and the ability to use materials other than expensive copper cables for transmitting messages. A common device for conducting or guiding waves of optical frequencies from one point to another is an “optical waveguide.” One commonly seen example of the optical waveguide is an optical fibre. The carrier waves of optical frequencies are transmitted while at the same time confined within a particular region in the waveguide. Useful optical waveguide devices must have, for example, low optical transmission loss, low optical absorbance, facile fabrication, controllable refractive index ratios, and high heat resistance.

Optical waveguides are usually coupled to a light source to transmit light from the light source to other optical devices. In the coupling between an optical waveguide and a light source, considerations are required to minimize the scattering loss and absorption loss. Lensed fibre is one method for light coupling between an optical fibre and a light source, for example a laser semiconductor chip. The best coupling occurs when the mode size from the lensed fibre exactly matches that from the laser source. However, in practice designing a special fibre in order to match a given laser is difficult, and the fibre is usually poorly matched with the laser. Furthermore, laser light emitted from a laser semiconductor chip may be reflected from the end of the optical fibre and the reflected laser light may cause problems including damage to the laser semiconductor chip itself.

### SUMMARY OF INVENTION

In view of the foregoing background, it is an object of the present invention to provide an alternative optical fibre and method of fabricating a coupling device for the same.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention, in one aspect, provides an optical fibre for coupling to an optical device which includes a core and a tip portion. The core is for receiving light directed from the optical source along an optical axis. The core is expanded near one end of the optical fibre, and the expanded core has a diameter larger than other portions of the core that are not expanded. The tip portion on the end of the optical fibre further includes an endmost face, the endmost face being non-perpendicular to the optical axis.

In another aspect of the present invention, a coupling system including an optical fibre and an optical device is disclosed. The optical fibre includes a core and a tip portion. The core is for receiving light directed from the optical source along an optical axis. The core is expanded near one end of the optical fibre, and the expanded core has a diameter larger than other portions of the core that are not expanded. The tip portion on the end of the optical fibre further includes an endmost face, the endmost face being non-perpendicular to the optical axis.

In a further aspect of the present invention, a method of fabricating a coupling device for an optical fibre for coupling to an optical device includes the steps of expanding a portion of a core in the optical fibre near one end of the optical fibre; the core capable of receiving light directed from the optical source along an optical axis; the expanded core after the expansion having a diameter larger than other portions of the core that are not expanded; and forming a tip portion on the end of the optical fibre, wherein the tip portion further comprises an endmost face, the endmost face being non-perpendicular to the optical axis.

There are many advantages to the present invention. One advantage is that the optical fibre as described in the present invention with an angled endmost surface and the expanded core is capable of achieving a high coupling efficiency and low laser reflection for laser semiconductor chip. Due to the presence of the angled tip of optical fibre, the reflected laser is forced to travel in a direction having a certain inclined angle with respect to the optical axis along which the laser emitted by the laser semiconductor chip travels, so that the reflected laser light will not travel in the same path as it was transmitted forward. In this way, damage to the laser semiconductor chip that generates the laser can be avoided, and thus elongating the life of the chip.

Further, the single mode optical fibre according to the present invention can be used to match different lasers with a great flexibility, such that there is no need to make a specific optical fibre for every kind of laser device such as a laser diode. Depending on the characteristics of the specific laser diode, desired coupling efficiency can be made by correspondingly adjusting the expanded core portion of the optical fibre.

### BRIEF DESCRIPTION OF FIGURES

The foregoing and further features of the present invention will be apparent from the following description of preferred embodiments which are provided by way of example only in connection with the accompanying figures, of which:

FIG. 1a is a front view of an optical fibre with angled tip;

FIG. 1b is the left view of the optical fibre in FIG. 1a;

FIG. 1c is the top view of the optical fibre in FIG. 1a;

FIG. 2 showing the coupling system including the optical fibre and a laser source;

FIG. 3 is a flowchart showing the steps of an optical fibre fabrication process;

FIGS. 4a to 4c show the front view, the left side view and the top view of a raw optical fibre respectively, where the optical fibre is to undergo the fabrication process as shown in FIG. 3;

FIGS. 5a to 5c show the front view, the left side view and the top view of the optical fibre in FIGS. 4a to 4c respectively after a thermal expansion process;

FIGS. 6a to 6c show the front view, the left side view and the top view of the optical fibre in FIGS. 5a to 5c respectively after a first polishing process;

FIGS. 7a to 7c show the front view, the left side view and the top view of the optical fibre in FIGS. 6a to 6c respectively after a second polishing process; and

FIGS. 8a to 8c show the front view, the left side view and the top view of the optical fibre in FIGS. 7a to 7c respectively after a flaming process.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to optical coupling or connection either directly or indirectly via one or more optical means unless otherwise stated.

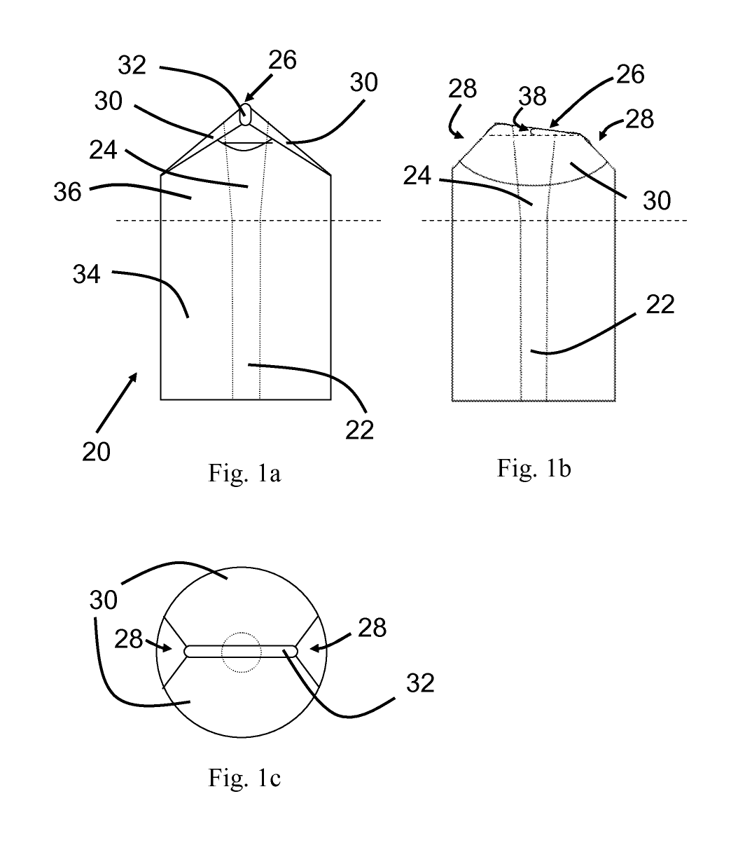

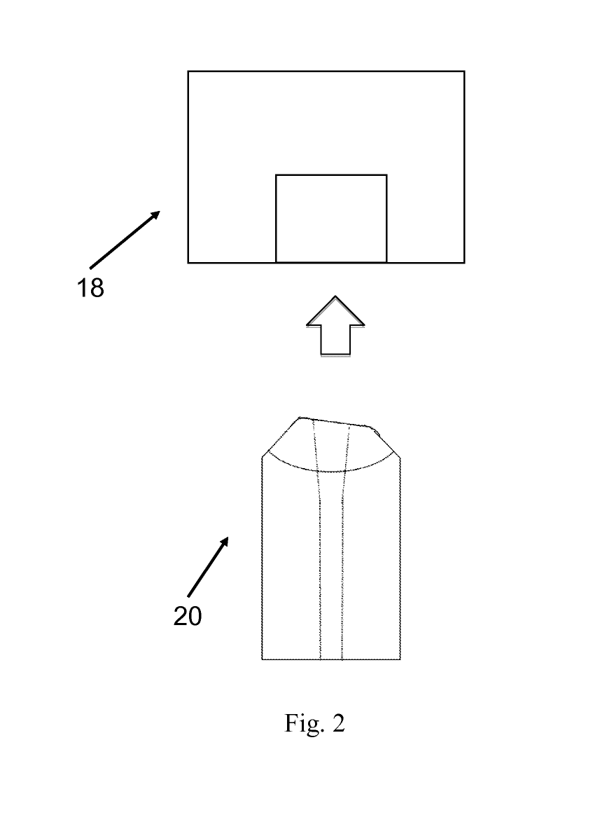

FIGS. 1a, 1b and 1c show part of an optical waveguide, which is an optical fibre 20 including a tip portion 36 and a trunk portion 34. The trunk portion 34 is the part of the optical fibre 20 that allows the laser signal to propagate therein and travels a desired geographical distance to the destination. The tip portion 36 refers to a portion of the optical fibre 20 near one of its ends. Within the trunk portion 34, there is a cylinder of glass or plastic that runs along the optical fibre's length, which is known as the core 22 of the optical fibre 20. The core 22 has a core diameter that is substantially constant throughout its length. There is also a core end portion 24 extending between the core 22 and the end of the optical fibre 20 as shown in FIGS. 1a, 1b and 1c. The core end portion 24 preferably has a taper shape. The core end portion 24 having a greater diameter than the core diameter of the core 22. More specific descriptions for this operation will be given later with reference to FIG. 2.

In the embodiment of FIGS. 1a to 1c, the tip portion 36 further contains an endmost face 26 at its farthest position on the end of the optical fibre 20. As shown in FIG. 1b, the endmost face 26 is not parallel with the diameter of the optical fibre 20, but has a tip angle 38 with respect to the diameter of the optical fibre 20. In other words, the endmost face 26 is non-perpendicular to an optical axis (not shown) along which a light is directed from an external optical device to the tip portion 36. In the embodiment shown in FIGS. 1a to 1c the optical axis is the longitudinal axis (not shown) of the core 22 of optical fibre. The tip angle 38 is determined according to for example the laser mode size, the incident light angle from the external optical device such as a laser diode, and the emitting power of the laser diode. The tip portion 36 further contains a lens 32 which is formed on an area overlapping with at least a part of the endmost face 26 of the tip portion 36. In a preferred embodiment the lens 32 occupies the whole area of the endmost face 26. The width of the lens 32 varies according to the laser mode size required, and the laser mode size is in turn determined by the characteristics of the emitting laser from a laser source such as a laser chip. The lens 32 as seen in the top view in FIG. 1a is in a substantially elliptical shape which is made by a flaming process that will be described in more detail later.

The tip potion 36 of the optical fibre 20 in FIGS. 1a to 1c further contains two side portions 30, each side portion 30 further including a surface extending from an outer peripheral of the optical fibre 20 toward the endmost face 26 of the tip portion 36. This can be best seen from FIG. 1a. The surface of each side portion 30 has an edge extending toward the endmost face 26 of the tip portion 36, and the edges of the side portions 30 contact the endmost face 26. Preferably, the tip portion 36 is substantially in a wedge shape, and the surfaces of the side portions 30 are symmetrical about the endmost face 26 of the lens 32. The angle of the wedge shape, i.e. the angle formed by the two surfaces of the side portions 30 is dependent on the laser mode size. The tip potion 36 of the optical fibre 20 further contains two chamfer portions 28 arranged near the two opposite ends of the endmost face 26. The chamfer portions 28 are configured to facilitate the proper coupling operation of the optical fibre into the optical device, such that the coupling will be made in a right direction and will not damage a laser chip in the optical device for instance. The angles of chamfer portions 28 are determined according to the specific optical device such as the laser semiconductor chip.

The optical fibre 20 shown in the embodiment of FIG. 1a to 1c is a single mode fibre that is best matched with a pump laser diode such as a 980 nm pump laser diode. The optical fibre 20 has a diameter of around 125 μm. Preferably, the tip angle 38 is approximately 6 degrees, or in other words an angle between a normal of the endmost face (not shown) that is perpendicular to the endmost face and the optical axis is approximately 6 degrees. The wedge angle, the tip angle, and the chamfers portions can all be varied in their designs to meet requirements of different optical devices with which the optical fibre is to couple.

FIG. 2 shows the optical fibre 20 as illustrated in FIGS. 1a to 1c that is to be coupled with an optical device 18, such as a laser semiconductor diode. The optical device 18 and the optical fibre 20 thus make up a coupling system. The optical fibre 20 in the embodiment of the present invention has a tip portion in a substantially wedge shape for the reason that this wedge shape can achieve a most desirable coupling efficiency when the single mode optical fibre is coupled with a 980 nm pump laser diode. Depending on the use of different laser diodes, the wedge shape can also be varied accordingly. The core end portion which has an expanded core can further help reduce the insertion loss due to the imperfect coupling between the optical fibre and other optical devices. On the other hand, the use of an angled lens with the tip angle achieves a low laser reflection back to the optical device that the optical fibre is coupled to, such as the laser semiconductor chip. Due to the presence of the angled lens, the back reflected laser as it goes into the tip portion of the optical fibre will be forced to travel in a different direction having a certain inclined angle with respect to the optical axis along which the laser goes into the tip portion. The back reflected laser will not travel back in the same straight path along which the laser was injected into the optical fibre. In other words, the back reflected laser light is deflected. In this way, the laser light, at least the major portion of it, will not go back to hit the surface of the laser semiconductor chip and thus the possible damage to the laser semiconductor chip can be avoided.

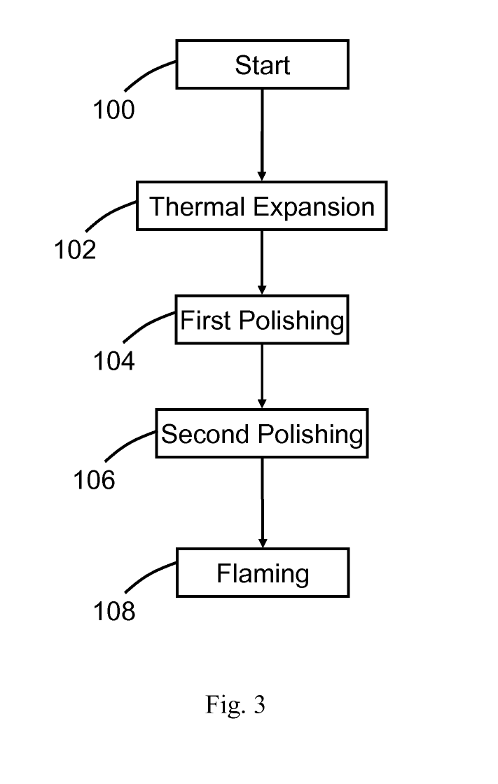

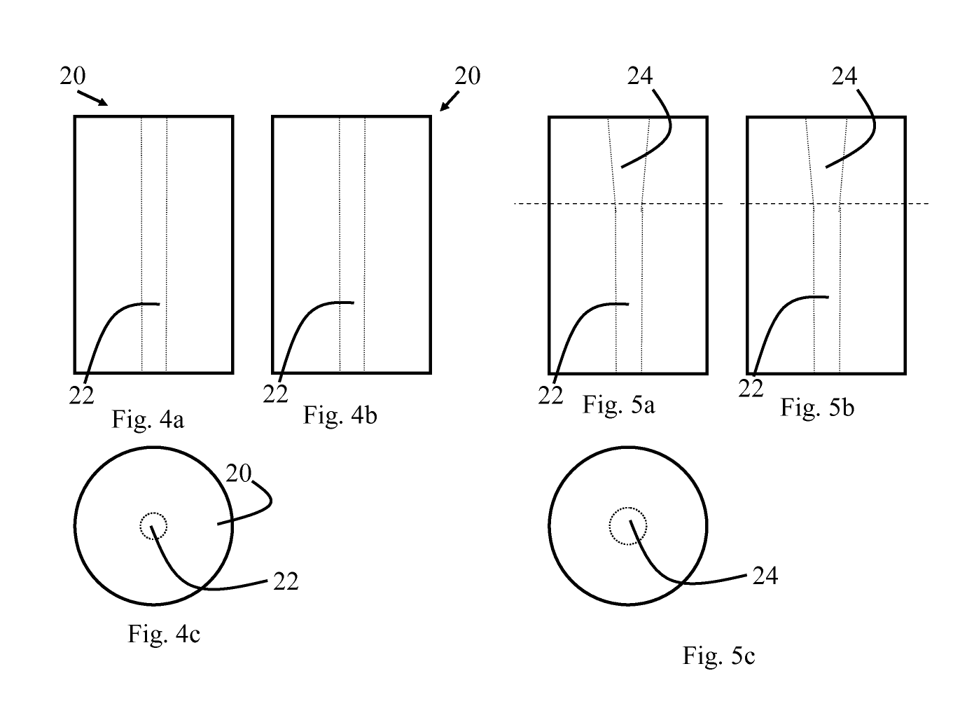

A method of fabricating an optical fibre for coupling to another optical device such as an optical source is described. This method in one embodiment contains several steps such as thermally expanding of the fibre core, polishing the fibre to form the desired shape of the tip portion and the lens, and flaming the optical fibre to form the final shape as shown in FIG. 3. The details of the steps in this embodiment are described below with reference to FIGS. 4a to 8c.

FIGS. 4a to 4c shows a raw optical fibre 20 at step 100 that has not been processed with the method described above. The optical fibre 20 has a cylindrical shape and inside the optical fibre 20 there is a core 22 located within the optical fibre 20 along the longitudinal axis of the optical fibre 20. The optical fibre 20 will firstly have to undergo a thermal expansion process 102 to expand a part of the core 22 to form a core end portion 24 in the optical fibre between the core 22 and an end of the optical fibre 20. The core end portion 24 has a greater diameter compared to the core 22. The optical fibre 20 after the thermal expansion process is shown in FIGS. 5a to 5c. Preferably, to match a 980 nm laser semiconductor chip the heating time of the optical fibre 20 is in the range of 4 minutes to 5 minutes. In a preferred embodiment, the heating time to the optical fibre 20 is around 4 minutes, which expands the fibre core to have around 7.1 μm in optical fibre mode field diameter (MFD).

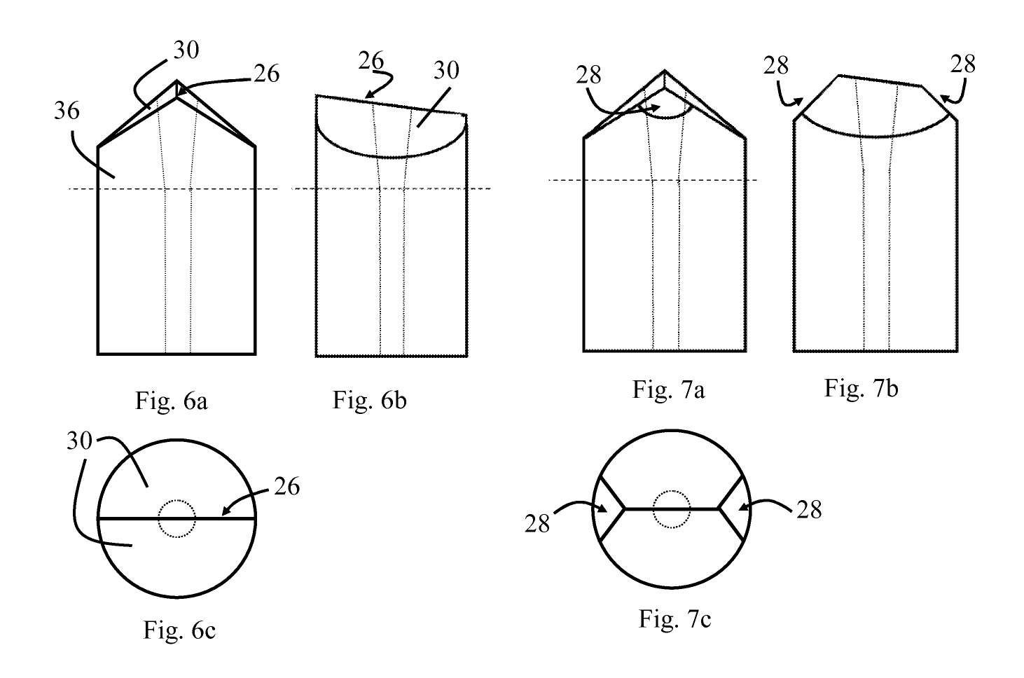

The optical fibre 20 will then go through a polishing process to form the wedge shape, the angled lens and the chamfers. The polishing process further contains a first polishing process 104 and a second polishing process 106. In the first polishing process 104, the tip portion 36 of the optical fibre is polished on its two sides if taking the view of the optical fibre shown in FIG. 5a as the front view. Preferably, the two sides of the tip proportion 36 are polished equally such that the two side portions 30 formed after the first polishing process 102 as shown in FIG. 6b both have the same surface areas and the surfaces have the same angles with regard to the axis direction of the optical fibre 20. This configuration of the two side portions 30 is also known as the wedge shape. At the same time, an endmost face 26 is formed across the center of the tip portion of the optical fibre due to the polishing to the two side portions 30. The endmost face 26 at this moment is in the shape of a sharp edge.

On the other hand, in the first polishing process 102, the polishing to the two side portions 30 are at a certain degree of angle, such that the endmost face 26 is not parallel to the diameter of the optical fibre 20, but has an inclined angle with respect to the diameter of the optical fibre. In other words, the endmost face 26 is non-perpendicular to an optical axis (not shown) along which a light is directed from an external optical device to the tip portion 36. This may be done for example by polishing more part of the tip portion in its front end than that in the back end of the tip portion 36. The front end and the back end of the tip portion 36 refer to the directions established in the views of FIGS. 6a to 6c. As mentioned above, the tip angle, i.e. the angle between the endmost face 26 and the diameter of the optical fibre, or the angle between a normal of the endmost face (not shown) that is perpendicular to the endmost face and the optical axis, is around 6 degrees.

In the second polishing process 106, as shown in FIGS. 7a to 7c, the tip portion 36 is further polished from two other directions which are perpendicular to that in the first polishing process 104. In particular, the front end and the back end of the tip portion 36 are polished to form two chamfers 28. The chamfers may have the same angles or different angles according to the requirement of the laser semiconductor chip, and this can be realized by controlling the polishing angles in the second polishing process 106.

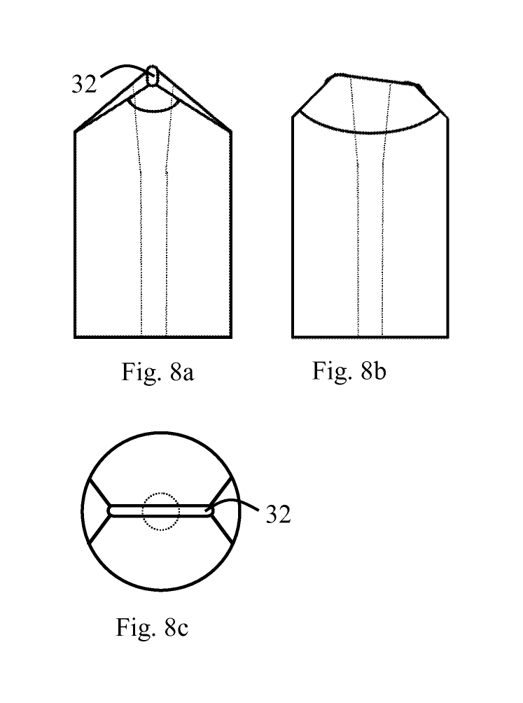

In the final flaming process 108, as shown in FIGS. 8a to 8c, the fibre tip in the tip portion (that is the area near the endmost face 26) is fusion spliced by an arc heating unit using electrodes. The heat generated by the arc will burn away the plastic in the optical fibre that covers the fibre core, and cause the glass to melt. The flaming process 108 thus causes the originally sharp endmost face 26 to become a relatively flat but uneven surface, because of the melting of glass at the fibre tip. However the flat surface may still be considered as a ridge of the tip portion. A lens 32 formed by this flat surface is thus made on the tip portion of the optical fibre. The lens 32 has an elliptical shape caused by the melting of glass at the fibre tip until reaching the boundaries of the previously formed wedge shape of the tip portion and the chamfer portions.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It is to be understood that, if any prior art publication is referred to herein, such reference does not constitute an admission that the publication forms a part of the common general knowledge in the art, in Australia or any other country.

Although in the above description to the embodiments of the present invention, a single mode optical fibre is used as an example of optical waveguide, those with ordinary skills in the art would realize that the teaching of the present invention may also be used on other types of optical waveguides with variations but still fall within the inventive ideas of the present invention. Examples of other optical waveguides include but are not limited to planar waveguide, strip waveguide, and multi-mode waveguide.

The tip portion of the optical fibre as describes has a substantially wedge shape for coupling with the 980 nm laser semiconductor chip. However, the tip portion does not necessarily have to be in a wedge shape. Depending on the geometrical dimension of the optical device that the optical fibre is coupled with, the shape of the tip portion of the optical fibre can be changed accordingly, as long as it can fits in to the optical device and does not impair the coupling efficiency. For example, in some circumstances the tip portion may have more than just two side portions. It may have three or even more side portions such as a polygon shape.

In the specific implementation described above, the tip angle of the endmost surface formed at the tip portion is around 6 degrees. However one skilled in the art should realize that this is not for the purpose of limiting the present invention. Depending on the type and specification of laser semiconductor chips, in particular their light emitting angle, the tip angle of the ridge formed at the tip portion can also be varied to meet the specific requirement.

In the embodiments of the present invention describing the method of manufacturing the optical fibre with angled tip above, a polishing process is used to produce the desired shape of the tip portion of the optical fibre and also to make the tip angle and chamfer portions. However, those skilled in the art would realize that there are many other approaches available in the industry besides polishing to cut/manipulate an optical fibre. Such approaches include but are not limited to cleaving, burning, or erosion.

1. An optical fibre for coupling to an optical source, the optical fibre comprising:
a) a core for receiving light directed from said optical source along an optical axis; wherein said core is expanded near one end of said optical fibre, the portion of the core which is expanded having a diameter larger than other portions of the core that are not expanded; and
b) a tip portion on said end of said optical fibre, wherein said tip portion further comprises an endmost face, said endmost face being non-perpendicular to said optical axis.

2. The optical fibre of claim 1, wherein said tip portion further comprises a lens such that said light transmitted from said optical source to said optical fibre goes through said lens.

3. The optical fibre of claim 2, wherein said lens is formed on an area overlapping with at least a part of said endmost face.

4. The optical fibre of claim 1, wherein said tip portion further comprises at least two side portions, each said side portion further comprising a surface extending from an outer periphery of said optical fibre toward said endmost face of said tip portion.

5. The optical fibre of claim 4, wherein said surface of each said side portion has an edge aligned with said endmost face of said tip portion, whereby said edges of said side portions contact said endmost face.

6. The optical fibre of claim 5, wherein said surfaces of said side portions are symmetrical about said endmost face of said tip portion and said tip portion is in a substantially wedge shape.

7. The optical fibre of claim 6, wherein said tip portion further comprises a first chamfer portion configured at a first end of said wedge.

8. The optical fibre of claim 7, wherein said tip portion further comprises a second chamfer portion configured at a second end of said wedge opposite to said first end.

9. The optical fibre of claim 1, wherein said endmost face of said tip portion further comprises an uneven surface.

10. The optical fibre of claim 1, wherein said diameter of said optical fibre is 125 μm.

11. The optical fibre of claim 1, wherein said optical fibre is a single mode optical fibre.

12. The optical fibre of claim 1, wherein an angle between a normal of said endmost face and said optical axis is approximately 6 degrees.

13. The optical fibre of claim 1, wherein said core end portion has a taper shape from said end of said optical fibre to said core.

14. A coupling system, comprising:
a) an optical device for generating a light signal; and
b) an optical fibre coupled to said optical device, wherein said optical fibre further comprises:
i) a core for receiving light directed from said optical source along an optical axis; wherein said core is expanded near one end of said optical fibre, said expanded core having a diameter larger than other portions of the core that are not expanded; and
ii) a tip portion on said end of said optical fibre, wherein said tip portion further comprises an endmost face, said endmost face being non-perpendicular to said optical axis.

15. The coupling system of claim 14, wherein said optical device is a laser semiconductor chip.

16. A method of fabricating a coupling device for an optical fibre for coupling to an optical source, comprising the steps of:
a) expanding a portion of a core in said optical fibre near one end of said optical fibre; said core capable of receiving light directed from said optical source along an optical axis; said expanded core after said expanding having a diameter larger than other portions of the core that are not expanded; and
b) forming a tip portion on said end of said optical fibre, wherein said tip portion further comprises an endmost face, said endmost face being non-perpendicular to said optical axis.

17. The method of claim 16, wherein said forming step further comprises the step of:
polishing said tip portion to form at least two side portions on said tip portion, each said side portion further comprising a surface extending from an outer peripheral of said optical fibre toward said endmost face of said tip portion.

18. The method of claim 17, wherein said surface of each said side portion has an edge extending toward said endmost face of said tip portion, whereby said edges of said side portions contacting said endmost face.

19. The method of claim 18, wherein said surfaces of said side portions are symmetrical about said endmost face of said tip portion and said tip portion is in a substantially wedge shape.

20. The method of claim 19, wherein said forming step further comprises the step of:
polishing said tip portion to form a first chamfer portion positioned at a first end of said wedge.

21. The method of claim 20, wherein said forming step further comprises the step of:
polishing said tip portion to form a second chamfer portion positioned at a second end of said wedge opposite to said first end.

22. The method of claim 16, wherein said method further comprises the step of:
flaming said tip portion of said fibre after said forming step to provide a lens on said tip portion.

23. The method of claim 22, wherein said lens is formed on an area encompassing at least a part of said endmost face.

24. The method of claim 16, wherein said expanding step is a thermal expanding process.

25. The method of claim 16, wherein said diameter of said optical fibre is 125 μm.

26. The method of claim 16, wherein said optical fibre is a single mode optical fibre.

27. The method of claim 16, wherein an angle between a normal of said endmost face and said optical axis is approximately 6 degrees.

28. (canceled)
